(19) United States
(12) Patent Application Publication
(10) Pub. No.: US 2018/0240157 A1
(43) Pub. Date: Aug. 23, 2018

(54) SYSTEM AND A METHOD FOR GENERATING PERSONALIZED MULTIMEDIA CONTENT FOR PLURALITY OF USERS

(71) Applicant: WIPRO LIMITED, Bangalore (IN)

(72) Inventor: Subramonian Gopalakrishnan, Ernakulam (IN)

(73) Assignee: Wipro Limited

(21) Appl. No.: 15/475,214

(22) Filed: Mar. 31, 2017

(30) Foreign Application Priority Data
Feb. 17, 2017 (IN) 201741005622

(51) Int. Cl. G06Q 30/02; G06N 3/08

(52) U.S. Cl. CPC G06Q 30/0269; G06N 3/08

(57) ABSTRACT

The instant disclosure relates to a system and method for generating personalized multimedia content to users. Plurality of predetermined multimedia content, along with associated stimuli, are displayed to users for detecting response of users for the displayed content and the stimuli. A reaction factor and an emotion dimension of the users are identified based on the response of the users. Finally, the personalized multimedia content is generated and presented to the users based on the emotion dimension and the reaction factor of the users. The instant method helps in identifying a best suited multimedia theme for the users based on analysis of innate insight of the behavior and preferences of the users, thereby enhancing the overall user experience.

### TECHNICAL FIELD

The present subject matter is related, in general to artificial intelligence, and more particularly, but not exclusively to a system and a method for generating personalized multimedia content for plurality of users.

### BACKGROUND

Most of the existing surveys may fail to capture the actual sentiment of people towards a campaign or a brand promotion since the people may be predisposed to hide their actual response and exhibit only a politically correct response. Hence, the existing surveys and feedback mechanisms may be inaccurate.

For instance, the existing methods may involve, mapping the needs of the customer to content of an offering through multimedia channels presented to the customer to drive commerce. Also, the multimedia channels may by design be tuned to feed the customers with the content and a context to build an ecosystem that helps to influence decisions and actions of the customer. Further, to build insights that go into the product improvisation, customer feedbacks/preferences may be captured. However, such feedbacks may fail to provide the innate insight of behavior of the customer. Also, cognitive dissonance may take over when the customer already has preconceived notions or conclusions, leading to failure of digital marketing.

A similar strategy that may be used in campaigning a brand or information is through the persuasive paradigm that relies on creating a sense of rapport and resonance with the customer so that they recognize and identify the needs of the customer. However, if the customer has already started to align with a different solution, then the recommendation may be at odds with their thinking. Moreover, conventional means of the digital marketing may fail to penetrate a target segment with biased and preconceived notions. In other words, when the customer has decided what to buy and where to buy even before shopping, conventional marketing interventions can hardly make an impact on the customer. Hence, the conventional marketing strategies may create a negative impact on that customer. Thus, there is a need to identify the self-influencing factor of the customers to generate a self-influencing multimedia based on emotions of the customers.

### SUMMARY

Disclosed herein is a method of generating personalized multimedia content for plurality of users. The method comprising displaying, by a multimedia content generator, plurality of Predetermined Multimedia Themes (PMTs) and associated one or more stimulus to the plurality of users. Upon displaying the plurality of PMTs, a reaction factor of each of the plurality of users in response to viewing of the plurality of PMTs and the associated one or more stimulus is detected. Further, a multimedia theme is identified from the plurality of PMTs for each of the plurality of users based on the reaction factor. Upon identifying the multimedia theme, an emotion dimension of each of the plurality of users is identified by comparing the reaction factor and one or more emotional metadata related to the one or more stimulus. Finally, the personalized multimedia content is generated for each of the plurality of users based on the multimedia theme and the emotion dimension corresponding to each of the plurality of users.

Further, the present disclosure discloses a multimedia content generator for generating personalized multimedia content for plurality of users. The multimedia content generator comprises a processor and a memory. The memory is communicatively coupled to the processor. Also, the memory stores processor-executable instructions, which, on execution, causes the processor to display plurality of Predetermined Multimedia Themes (PMTs) and associated one or more stimulus to the plurality of users. Upon display of the plurality of PMTs and associated one or more stimulus, the processor detects a reaction factor of each of the plurality of users in response to viewing of the plurality of PMTs and the associated one or more stimulus. Further, the processor identifies a multimedia theme, from the plurality of PMTs, for each of the plurality of users based on the reaction factor. Upon identification of the multimedia theme, the processor identifies an emotion dimension of each of the plurality of users by comparing the reaction factor and one or more emotional metadata related to the one or more stimulus. Finally, the processor generates the personalized multimedia content for each of the plurality of users based on the multimedia theme and the emotion dimension corresponding to each of the plurality of users.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1A and FIG. 1B shows exemplary environments for generating personalized multimedia content for plurality of users in accordance with some embodiments of the present disclosure;

FIG. 2 shows a detailed block diagram illustrating a multimedia content generator for generating personalized multimedia content for plurality of users in accordance with some embodiments of the present disclosure;

FIG. 3 shows a flowchart illustrating a method of generating personalized multimedia content for plurality of users in accordance with few embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a system for generating personalized multimedia content for plurality of users. In general, the method involves generating one or more linked and/or associated multimedia content for evoking progressive emotional engagement with the plurality of users (viewers of the multimedia content). In an embodiment, the emotional engagement with the plurality of users may be used to promote a product or a brand by displaying interlinked multimedia content over multiple episodes across different multimedia channels. Here, a multimedia campaign may be designed in such a way that the paradigm for campaigning are selected and spread by understanding psyche of the plurality of users. The method and the system also involves capturing the innate insight into preferences/behaviors of the plurality of users by presenting a series of audio-visual stimulus, which would invoke some neural responses in the plurality of users.

Further, the instant method would be useful in transforming the entire marketing intervention to a more predictable, outcome-driven activity. With the advancement in technology, it would be much easier to go closer to the customers, understand deep insights of the customers and motivate them towards a desired outcome without going around about the conventional digital marketing cycle.

The key principles that are considered to arrive at the instant method include:
a. Self-influence: Individualistic personalities would prefer to be their masters and hence own their ideas. Therefore, it would be important that they feel that the idea was truly theirs.
b. Art of storytelling: The emotions created within the nested story do not stay inside the story. Rather, they follow the readers across the frame of the story. Often, the nested stories create illusion of separation thinning between a surreal world and a real world. Thus, they help to create a foresight of possible outcomes to a real situation from the surreal world.
c. Emotion dimension: The constituents of emotion includes the premise of what the person stands for as in his identity and the relationships that the person builds with the touch points.

Accordingly, each personalized multimedia content generated as per the system and the method may be characterized by three components—insight of a deep desire, a nested story in multiple levels and a hook to connect to deep emotions of the users. The first component emphasizes the “Self-influence” or the “Intrinsic drive”. This also connects to the core “Emotion dimension” of a person. The second component is the core platform that drives the self-driven grooming of the desire of the plurality of users. The subplots or storyline of the personalized multimedia content may be devised based on the context and objective of the multimedia theme. The subplots may include small information, which are designed to trigger the interest in the users towards the respective multimedia theme/multimedia content, thereby evoking nostalgia and bringing out positive emotions related to the predefined multimedia theme. In an embodiment, the subplots may exist in a nested format, where each small information are interlinked to the other small information related to the multimedia theme. Here, each subplot may be inspired from or based on the multimedia theme. Each sub plot may attempt to seed ideas into the users' head. For instance, seeding the idea of buying the brand or product being promoted.

Thus, the instant disclosure discloses a method of identifying the multimedia themes that invoke maximum positive trigger (self-influence) in the users/viewers' mind. Later, multiple groups of the viewers may be formed by clustering the viewers based on the insight got from the predefined set of viewers. This helps in identifying the multimedia theme that may be campaigned for each cluster of the viewers. In an embodiment, the identified multimedia themes may not be campaigned directly. But, each of the multimedia themes may be divided into several subplots. Each subplot may include a small information that triggers the interest in the viewers towards the respective multimedia theme. As an example, the subplots may be any media content such as a video, an audio, a text, or an image or a virtual reality simulation or a virtual reality game. The sequential nested subplots may ultimately implement the nested story telling methodologies to unleash the power of self-influence.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

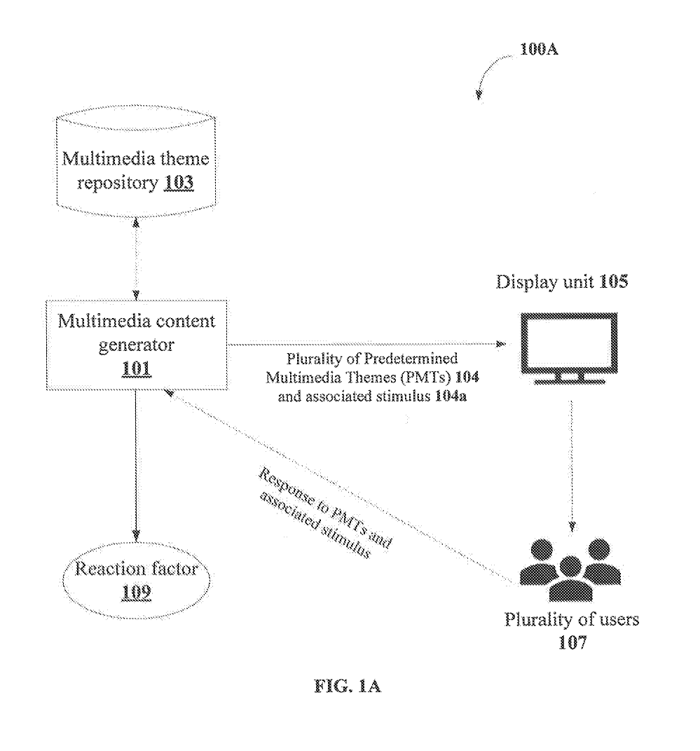

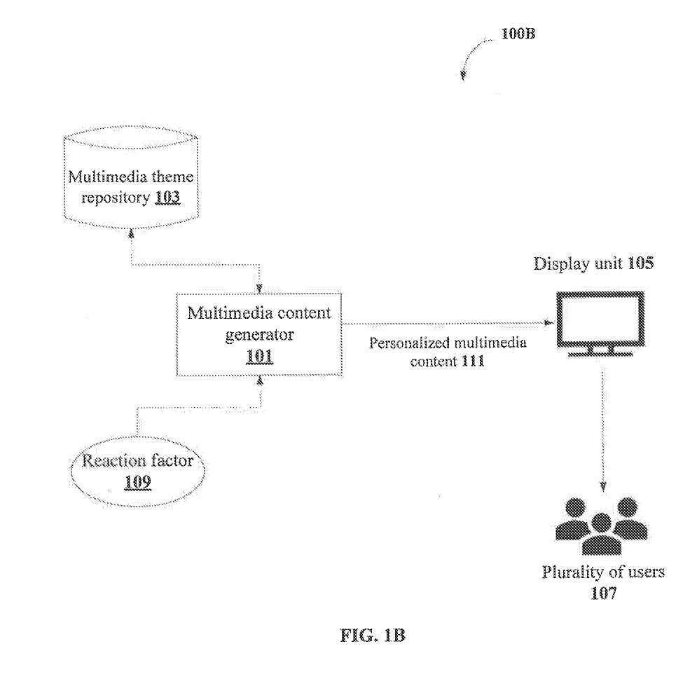

FIGS. 1A and 1B show exemplary environments for generating personalized multimedia content 111 for plurality of users in accordance with some embodiments of the present disclosure.

Accordingly, environment 100A may comprise a multimedia content generator 101 for generating personalized multimedia content for plurality of users 107. Initially, the multimedia content generator 101 may display plurality of Predetermined Multimedia Themes (PMTs) 104 and associated one or more stimulus 104a to the plurality of users 107 through the display unit 105 associated with the user. In an embodiment, the plurality of PMTs 104 may be related to one or more brands or consumer products that are to be campaigned and/or advertised to the plurality of users 107. As an example, the plurality of PMTs 104 may be related to, healthcare, beauty and personal care, economy, comfort and the like. Further, the one or more stimulus 104a associated with the plurality of PMTs 104 may be audio/visual content, which can invoke some neural responses in the plurality of users 107 when the plurality of users 107 view the plurality of PMTs 104 and the associated one or more stimulus 104a. In an example, the one or more stimulus 104a may be used to capture innate aspects of each of the plurality of users 107, such as ethnicity, associations, most extreme points of emotional oscillation and gender equations, which are considered while selecting the multimedia theme.

In another example, the one or more stimulus 104a may be designed such that, the one or more stimulus 104a may provide feedback about each of the plurality of users 107 on the emotional associations (or favoritism) of each of the plurality of users 107, as well as association level such as noticing, identifying, sharing and advocating nature of each of the plurality of users 107. The one or more stimulus 104a may be created to identify the desire, belief and intention of the plurality of users 107. In an embodiment, the plurality of PMTs 104 and the associated one or more stimulus 104a may be stored in a multimedia theme repository 103 associated with the multimedia content generator 101.

In an embodiment, after displaying the plurality of PMTs 104 and the associated one or more stimulus 104a to the plurality of users 107, the multimedia content generator 101 may detect the response of each of the plurality of users 107 for the plurality of PMTs 104 and the associated one or more stimulus 104a. The response of each of the plurality of users 107 may be detected using one or more emotion detection sensors. As an example, the one or more emotion detection sensors may include plurality of neuroprosthetic devices, without limiting to, at least one of a neural dust sensor, an electroencephalogram, an electro-oculogram, electrodermal sensor and the like. In an embodiment, the response of each of the plurality of users 107 may indicate one of presence or absence of an aroused neural signal in each of the plurality of users 107.

In an embodiment, upon detecting the response of the plurality of users 107, the multimedia content generator 101 may detect a reaction factor 109 of each of the plurality of users 107 in response to viewing of the plurality of PMTs 104 and the associated one or more stimulus 104a. The reaction factor 109 of each of the plurality of users 107 is a measure of the intensity of reaction/response of the user for the plurality of PMTs 104 and the associated one or more stimulus 104a. As an example, the reaction factor 109 may include, without limiting to, level of self-influence of the plurality of users 107, intrinsic drive of the plurality of users 107, emotion of the plurality of users 107, attitude of the plurality of users 107 or influence of the plurality of PMTs 104 and the associated one or more stimulus 104a on the plurality of users 107. Further, the reaction factor 109 may be a combination of aroused neural signals and physical responses such as, user interaction, body movement patterns, eye movement patterns, head movement patterns, facial expressions, vital signs and the like. In an implementation, the presence of aroused neural signals and physical responses may be detected using the one or more emotion detection sensors and other devices such as a head gear unit, a wearable sensor body suit or peripheral cameras. The reaction factor 109 of each of the plurality of users 107 may be considered for identifying a multimedia theme for each of the plurality of users 107 as illustrated in FIG. 1B.

In an embodiment, as shown in environment 100B in FIG. 1B, the multimedia content generator 101 may use the reaction factor 109 of each of the plurality of users 107 to identify a multimedia theme, corresponding to each of the plurality of users 107, from the plurality of PMTs 104 stored in the multimedia theme repository 103. In an embodiment, the multimedia theme may be identified by assigning an emotional score to each of the plurality of PMTs 104 based on the reaction factor 109 and then selecting one of the plurality of PMTs 104 having the emotional score greater than a predefined threshold.

Further, the multimedia content generator 101 may identify an emotion dimension of each of the plurality of users 107 by comparing the reaction factor 109 with one or more emotional metadata related to the one or more stimulus 104a. As an example, the one or more emotional metadata may include, without limiting to, awareness level of the plurality of users 107, acceptance level of the plurality of users 107, emotional bias of the plurality of users 107, cognitive capability of the plurality of users 107 or sensitivity of the plurality of users 107 for the one or more stimulus 104a. Here, each element in the reaction factor 109 of each of the plurality of users 107 may be compared with the one or more emotional metadata to identify similarity in the response of each of the plurality of users 107 and the one or more emotional metadata.

In an embodiment, upon identifying the multimedia theme and the emotion dimension of each of the plurality of users 107, the multimedia content generator 101 may generate the personalized multimedia content 111 for each of the plurality of users 107 based on the multimedia theme and the emotion dimension corresponding to each of the plurality of users 107. Further, the multimedia content generator 101 may display the personalized multimedia content 111 to the plurality of the users through the display unit 105. Furthermore, the multimedia content generator 101 may generate a plurality of associated multimedia content (subplots) that are related to the personalized multimedia content 111, based on response of the plurality of users 107 to the personalized multimedia content 111 displayed to the plurality of users 107. In an implementation, the multimedia content generator 101 may identify a multimedia channel and an optimized schedule and/or time slot in the identified multimedia channel to display the personalized multimedia content 111 and the plurality of associated multimedia content to the plurality of users 107.

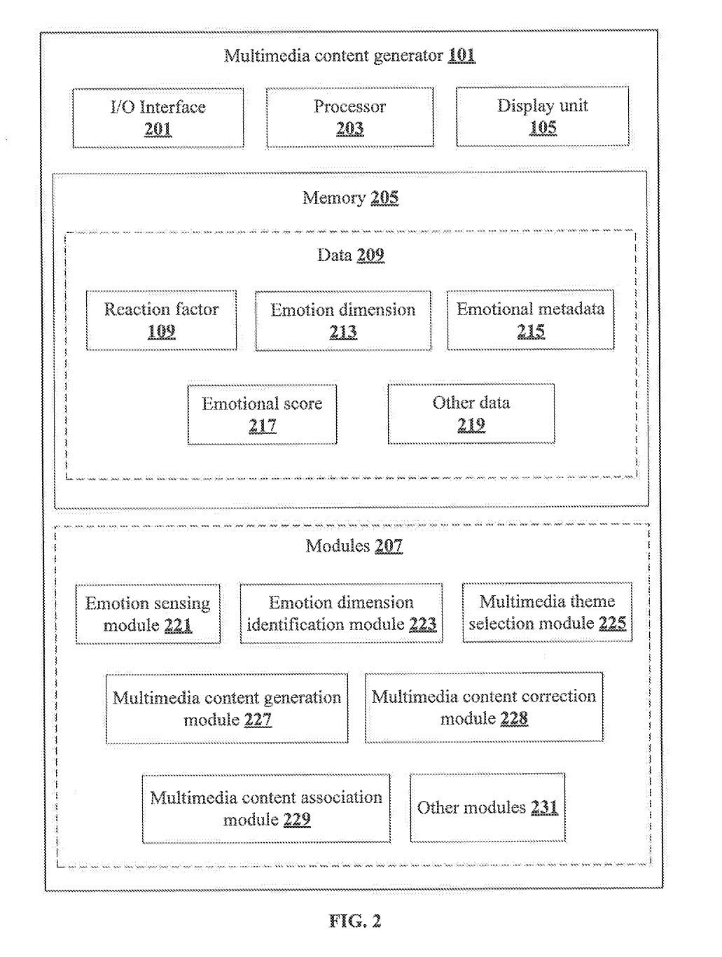

FIG. 2 shows a detailed block diagram illustrating a multimedia content generator 101 for generating personalized multimedia content 111 for plurality of users 107 in accordance with some embodiments of the present disclosure.

The multimedia content generator 101 may comprise an I/O interface 201, a processor 203, a memory 205 and a display unit 105. The I/O interface 201 may be configured to access the plurality of PMTs 104 and the associated one or more stimulus 104a, which are stored in the multimedia theme repository 103. The display unit 105 may be used to display the plurality of PMTs 104 and the associated one or more stimulus 104a to the plurality of users 107. The memory 205 may be communicatively coupled to the processor 203. The processor 203 may be configured to perform one or more functions of the multimedia content generator 101 for generating the personalized multimedia content 111 for each the plurality of users 107. In one implementation, the multimedia content generator 101 may comprise data 209 and modules 207 for performing various operations in accordance with the embodiments of the present disclosure. In an embodiment, the data 209 may be stored within the memory 205 and may include, without limiting to, a reaction factor 109, an emotion dimension 213, one or more emotional metadata 215, an emotional score 217 and other data 219.

In one embodiment, the data 209 may be stored within the memory 205 in the form of various data structures. Additionally, the data 209 may be organized using data models, such as relational or hierarchical data models. The other data 219 may store data, including temporary data and temporary files, generated by modules 207 while generating the personalized multimedia content 111 for the plurality of users 107.

In some embodiments, the reaction factor 109 of each of the plurality of users 107 may be detected based on the response of each of the plurality of users 107 upon viewing the plurality of PMTs 104 and the associated one or more stimulus 104a. The reaction factor 109 is a measure of the intensity of reaction/response of the user for the plurality of PMTs 104 and the associated one or more stimulus 104a. As an example, the reaction factor 109 may include, without limiting to, level of self-influence of the plurality of users 107, intrinsic drive of the plurality of users 107, emotion of the plurality of users 107, attitude of the plurality of users 107 or influence of the plurality of PMTs 104 and the associated one or more stimulus 104a on the plurality of users 107. The reaction factor 109 of each of the plurality of users 107 may be considered for identifying a multimedia theme for each of the plurality of users 107. Further, the reaction factor 109 may be compared with the one or more emotional metadata 215 related to the one or more stimulus 104a for identifying the emotion dimension 213 of each of the plurality of users 107.

In some embodiments, the one or more emotional metadata 215 may include, without limiting to, an awareness level of the plurality of users 107, an acceptance level of the plurality of users 107, an emotional bias of the plurality of users 107, cognitive capability of the plurality of users 107 or sensitivity of the plurality of users 107 for the one or more stimulus 104a. The one or more emotional metadata 215 related to the one or more stimulus 104a may be compared with the reaction factor 109 of each of the plurality of users 107 for identifying the emotion dimension 213 of each of the plurality of users 107.

In some embodiments, the emotion dimension 213 of each of the plurality of users 107 may be identified by comparing the reaction factor 109 and the one or more emotional metadata 215 related to the one or more stimulus 104a. As an example, the emotion dimension 213 of each of the plurality of users 107 may be used for predicting the emotional receptiveness and likely emotional state of each of the plurality of users 107. The emotion dimension 213 may be used to determine whether each of the plurality of users 107 are conscientious about the plurality of PMTs 104 and the associated one or more stimulus 104a, which are displayed to the plurality of users 107. The emotion dimension 213 may also help to determine whether the plurality of users 107 agree to perceptions of other users or if the plurality of the users only try to put their ideas on top of others. The sensitivity of the plurality of users 107 to certain things and the way that the plurality of users 107 express their emotions may also be determined based on the emotion dimension 213. Further, an emotional polarity of each of the plurality of users 107 may be identified using the emotion dimension 213 of each of the plurality of users 107. Here, the emotional polarity categorizes the emotion of the plurality of users 107 into one of a positive, a negative, or a neutral emotion for determining compatibility, incompatibility or partial compatibility between the plurality of users 107 and the plurality of PMTs 104 displayed to the plurality of users 107.

In some embodiments, the emotional score 217 of each of the plurality of PMTs 104 may represent the impact of each of PMTs 104 on each of the plurality of users 107, which is identified based on the reaction factor 109 of each of the plurality of users 107. As an example, one of the plurality of PMTs 104 that creates a higher impact on the plurality of users 107 may be assigned a high emotional score 217, say 8 out of 10. Similarly, the plurality of PMTs 104 that do not create any impact or that do not result in an aroused response from the plurality of users 107 may be assigned a low emotional score 217. In an embodiment, one of the plurality of PMTs 104, which has the emotional score 217 greater than a predefined threshold, say 6 out of 10, may be selected and used for identifying the multimedia theme for the plurality of users 107.

In some embodiment, the data 209 may be processed by one or more modules 207 in the multimedia content generator 101. In one implementation, the one or more modules 207 may be stored as a part of the processor 203. In another implementation, the one or more modules 207 may be communicatively coupled to the processor 203 for performing one or more functions of the multimedia content generator 101. The modules 207 may include, without limiting to, an emotion sensing module 221, an emotion dimension identification module 223, a multimedia theme selection module 225, a multimedia content generation module 227, a multimedia content correction module 228, a multimedia content association module 229 and other modules 231.

As used herein, the term module may refer to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 231 may be used to perform various miscellaneous functionalities of the multimedia content generator 101. It will be appreciated that such modules 207 may be represented as a single module or a combination of different modules.

In some embodiments, the emotion sensing module 221 may be responsible for detecting and capturing the response of the plurality of users 107 for the plurality of PMTs 104 and the associated one or more stimulus 104a displayed to the plurality of users 107. In an implementation, the emotion sensing module 221 may include plurality of neuroprosthetic devices such as, without limitation, a neural dust sensor, an electroencephalogram, an electro-oculogram or an electrodermal sensor. Each of the one or more emotion detection sensors may be pre-configured and/or administered on to each of the plurality of users 107 before displaying the plurality of PMTs 104 and the associated one or more stimulus 104a to the plurality of users 107. Further the emotion sensing module 221 may be responsible for tracking and recording the responses of the plurality of users 107 against the one or more stimulus 104a associated with the plurality of PMTs 104.

Furthermore, the emotion sensing module 221 may be configured to capture the presence or absence of the aroused neural signal in response to the display of the plurality of PMTs 104 and associated one or more stimulus 104a to the plurality of users 107 for evaluating the reaction factor 109 of each of the plurality of users 107. Here, the captured emotional responses i.e. the aroused neural signals may be binary in nature. In an example, the reaction factor 109 may be detected from a combination of aroused neural signals and physical responses such as interaction of the plurality of users 107, body movement patterns, eye movement patterns, head movement patterns, facial expression and other vital signs, which may be sensed using monitoring devices like head gear unit, wearable sensor body suit, peripheral cameras and so on. In an example the response of the plurality of users 107 may include deep nerve signals (neural responses) generated from nervous system of the plurality of users 107. In an embodiment, the neural responses captured by the emotion sensing module 221 may be translated into electric waves, which clearly identify the source of the response and the nature of the response.

In an embodiment, the emotion dimension identification module 223 may be responsible for identifying the emotion dimension 213 of each of the plurality of users 107 by comparing the reaction factor 109 and one or more emotional metadata 215 related to the one or more stimulus 104a. The emotion dimension identification module 223 may help in analyzing the correlations between the plurality of users 107 and the plurality of PMTs 104 using analysis techniques such as, pattern recognition, feature analysis and deep machine learning techniques. The emotion dimension 213 identified by the emotion dimension identification module 223 may be used for predicting the emotional receptiveness and likely emotional state of each of the plurality of users 107. The emotion dimension 213 helps in determining whether each of the plurality of users 107 are conscientious about the plurality of PMTs 104 and the associated one or more stimulus 104a, which are displayed to the plurality of users 107. The emotion dimension 213 would also help to determine whether the plurality of users 107 agree to perceptions of other users or if the plurality of the users only try to put their ideas on top of others. The sensitivity of the plurality of users 107 to certain things and the way that the plurality of users 107 expresses their emotions may also be determined based on the emotion dimension 213.

In an embodiment, the multimedia theme selection module 225 may be responsible for assigning the emotional score 217 to each of the plurality of PMTs 104 and to identify the multimedia theme to be provided to the plurality of users 107 based on the emotional score 217 of each of the plurality of PMTs 104. The emotional score 217 assigned by the multimedia theme selection module 225 to each of the plurality of PMTs 104 may indicate the self-influence, intrinsic drive, emotion and attitude of the plurality of users 107 in response to viewing the plurality of PMTs 104. In an embodiment, the emotional score 217 may indicate the sensitivity and attentiveness of the plurality of users 107 towards the plurality of PMTs 104 that are displayed to the plurality of users 107.

Upon determining the emotional score 217 of each of the plurality of PMTs 104, the multimedia theme selection module 225 evaluates the plurality of PMTs 104 on a scale extending between a “detached” feeling and an “attached” feeling based on the emotional score 217. Here, the “detached” feeling (corresponding to a lower emotional score 217) represents a feeling that the user has, of not being able to personally connect to the plurality of the PMTs 104 and the “attached” feeling (corresponding to higher emotional score 217) represents a feeling that the user has, of a personal connection to the plurality of PMTs 104. In an embodiment, the multimedia theme selected by the multimedia theme selection module 225 may be a personalized theme for each of the plurality of users 107 and matched with the reaction factor 109 and the emotion dimension 213 of the plurality of users 107.

In an embodiment, the multimedia content generation module 227 may be responsible for generating the personalized multimedia content 111 for the plurality of users 107 based on the multimedia theme selected by the multimedia theme selection module 225 and the emotion dimension 213 identified by the emotion dimension identification module 223. In an example, the personalized multimedia content 111 generated for the plurality of users 107 may be a nested story in multiple levels, which captures the interests of the plurality of users. Further, the personalized multimedia content 111 generated for the plurality of users 107 may help in delving into deep insights of the plurality of users 107 and to draw affiliation to incept the interests and desire of the plurality of users 107.

In an embodiment, each personalized multimedia content 111 generated by the multimedia content generator 101 may be characterized mainly by three components—the insight of a deep desire in the plurality of users 107, a nested story in multiple levels and a hook to capture the interests of the plurality of users 107. The first component emphasizes on the “Self-influence” or “intrinsic drive” of the multimedia theme which is selected based on the emotional score 217. The second component drives the self-driven grooming of the desire of the plurality of users 107. Further, the personalized multimedia content 111 may be devised or modified as per the context and objective based on which the personalized multimedia content 111 was generated on the multimedia theme and the emotion dimension 213. The third component deals with marketing and technology interventions that are innovative and cutting edge technologies to ensure that the personalized multimedia content 111 reaches the target, i.e., the plurality of users 107.

In an embodiment, the personalized multimedia content 111 may include information that can trigger the interest in the plurality of users 107 towards the respective personalized multimedia content 111. As an example, the information may be a media content such as a video, an audio, a text, an image, a virtual reality simulation or a virtual reality game. In some embodiments, the personalized multimedia content 111 may exist in a nested format, where each information about the personalized multimedia content 111 are interlinked to the information related to the personalized multimedia content 111. Here, each of the personalized multimedia content 111 may act as an intervention towards the selected multimedia theme.

In an embodiment, the multimedia content association module 229 may be responsible for creating multiple groups among the plurality of users 107 based on socio-demographic data patterns of the plurality of users 107. Then, the personalized multimedia content 111 associated with each of the multiple groups may be provided and/or displayed to each of the plurality of users 107 in each of the multiple groups.

In an embodiment, the multimedia content correction module 228 may be responsible to self-correct and/or modify the personalized multimedia content 111 based on response of each of the plurality of users 107 by fine-tuning the selected multimedia theme for each of the multiple user group. The fine-tuning of the multimedia theme may be based on the effectiveness of the multimedia themes, which is identified from the response of the plurality of users 107 to the propagated/displayed personalized multimedia content 111.

In an embodiment, the multimedia content correction module 228 may change the selected multimedia theme based on a poor response from the multiple groups of plurality of users 107 by identifying next personalized theme based on the emotional score 217. In one example, online responses from each of the plurality of users 107 may be captured from social buzz, traffic conversions, likes, sharing, re-tweets, comments, followers, re-blog and the like. In an embodiment, when the online response of the displayed personalized multimedia content 111 does not reach a pre-defined (expected) level of online response of viewers, then the corrective multimedia content may be identified and displayed to the plurality of users. The nested story line within the personalized multimedia content 111 may expand to create a conducive environment, in which outputs at the end of each sub-story need to be mapped to the expected behavioral outcome of the plurality of users 107.

In some embodiments, the multimedia content generator 101 further comprises identifying a best effective multimedia channel to propagate the personalized multimedia content 111 related to the selected multimedia theme by analyzing the historical channel usage data of each of the plurality of users 107. Further, the multimedia content generator 101 may be configured to propagate the personalized multimedia content 111 to the multiple groups of the plurality of users 107. The propagation of the personalized multimedia content 111 may be performed in a sequential manner through the identified best effective multimedia channel, for establishing an emotional engagement with each of the plurality of users 107.

A General Scenario:

In an illustration, the multimedia content generator may be used to assist a child in emerging from the child's addiction to television. The following steps may ensue

Level 1 Sub-Plot:

Initial step may be to question status-quo. Here, it may be necessary to identify and propose some event that may replace Television programs that the child may be accustomed to watching. Now, it may be important to determine how to wane out TV watching and at the same time build interest in sports. One way to enhance the status quo and still promote the change in the child may be to watch sports movies along with the child, thereby familiarizing the child with the sport. Some other alternatives could be like offering a play station or a Wii to the child.

Level 2 Sub-Plot:

Having familiarized the child with the sport, now the key need may be to motivate the child to involve in sports. This may be done either by familiarizing the stalwarts of sports and their achievements to the child if that generates interest or by explaining the kid using a parallel scenario that relates to a current scenario. For example, if football is the game, then, either all the famous old time footballers may be familiarized with their signature moves, spectacular goals or milestones and achievements. Other option may be to expose the child to popular football players like Ronaldo & Messi and the professional competition between them. Video games on Play stations or online games may also be good alternatives to the above. Once the affiliation is formed, then demonstration would be of great help. Playing virtual games or experiencing a realistic game using 3D holographic images of live matches etc. could increase the impact on the child. Virtual simulation then must be followed up with real training. Jerseys and accessories of favorite stars and teams could act as motivation builders and sometimes as confidence boosters while training.

Level 3 Sub-Plot:

The final step may be to build self-influence in the child. By now, the child would have started playing the game. The objective here may be to take it to next level, so that the TV shows does not haunt the child again. Therefore, the child must be put into real in-stadium experiences. So, all real-time activities including meeting and greeting players, being part of the cheering fan club or even meeting the great stars of the game and collecting memorabilia could be pre-planned and arranged, thereby creating a permanent impact on the child. In the meantime, while monitoring the TV watching patterns of the kid, the kid must be reminded of alternatives available on football whenever the kid switches to cartoons. After a brief period of observation and intervention, the kid would develop the potential to change himself/herself into a football aficionado.

The above general scenario may be implemented in real-time events as explained below:

A Launch Event:

During a launch event, mass surveys using plurality of neuroprosthetic devices for emotion capturing, such as EOG, EEG, EDA or Neural Dust. The emotion capturing tools may be used to tap the response of users towards one or more stimulus 104a instigated by a special event. For example, at the launch of a flagship product, where crowd from various walks of life have assembled, the moment the product is unveiled may be the most vulnerable point at which raw responses may be given out by the brains of the crowd. These raw responses, at a later stage, may likely be altered by the brain to give a politically correct response, rather than an actual response. Surveys and feedback mechanisms are often influenced by this behavior of the crowd and hence most often the surveys and the feedback mechanisms may be inaccurate.

Hence, using wearable sensors to tap the immediate neural responses may in a conventional way assist in tapping the perception insights of the crowd. Accordingly, volunteers may be administered with sensors, that tap into the nervous system to project clear response to one or more stimulus 104a. Further, interpreter algorithms may be used to analyze the responses, attach them to the (identified/unidentified) source, compare the inputs with the data from other sources and eventually develop the emotion dimension 213 and the reaction factor 109 of the crowd. Also, sentimental analysis may get more accurate especially when the responses are binary. Insights during trailer launch of movies and election rallies would help in conceptualizing a win theme, whereas the same on a long running show or theatrical event would help to improvise the event as per the interests of the audience.

Stock Market Scenario:

Consider a trading application that extends the same feel of a stock market, i.e., energy, emotions, euphoria and vibrancy to a broker or a sub broker sitting in a tiny room and working on the broker's laptop. A simulation of the actual stock market on a virtual reality application could generate this ambience. To add to this, if the Stock Market could be played with online friends within a virtual world by dynamically building the Stock Market Floor combining sessions from multiple players through the application, then the players would be put through a real-life situation. However, the players won't be alone there as they can bring in their partners and friends by putting sessions on conference mode.

The above scenarios explain various ways of disturbing the status-quo and changing the behavior of users in stages. The cognitive platforms that are deployed in robotic automation or insight driven marketing of today could be made sharper and impactful by enhancing the instant invention.

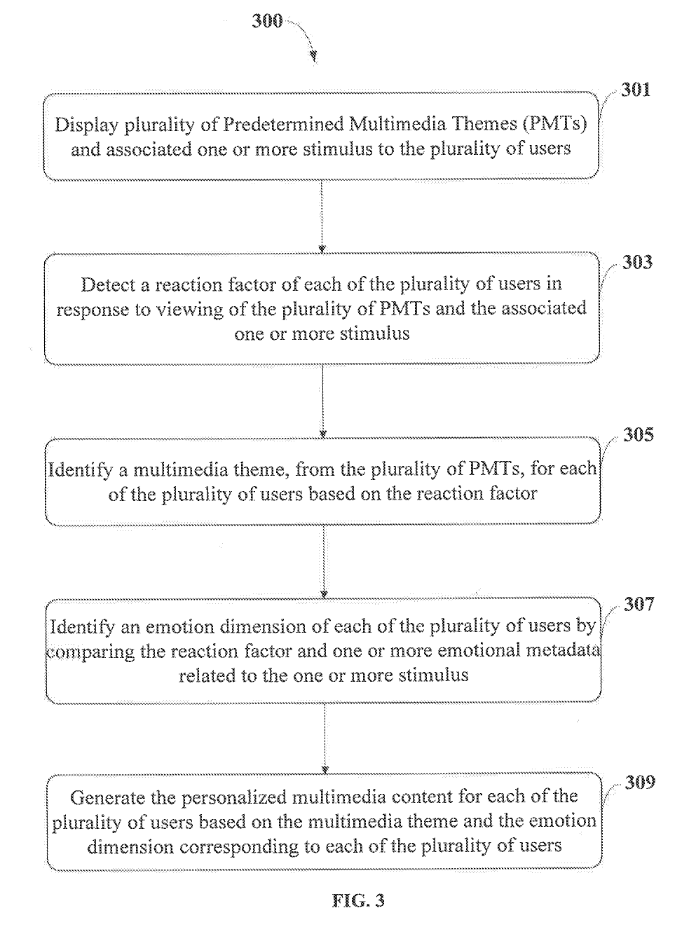

FIG. 3 shows a flowchart illustrating a method of generating personalized multimedia content 111 for plurality of users 107 in accordance with few embodiments of the present disclosure.

As illustrated in FIG. 3, the method 300 comprises one or more blocks for generating personalized multimedia content 111 for plurality of users 107 using a multimedia content generator 101. The method 300 may be described in the general context of computer executable instructions. Generally, computer executable instructions can include routines, programs, objects, components, data structures, procedures, modules, and functions, which perform specific functions or implement abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301 of the method 300, the multimedia content generator 101 displays plurality of Predetermined Multimedia Themes (PMTs) 104 and associated one or more stimulus 104a to the plurality of users 107. In an embodiment, the multimedia content generator 101 may monitor each of the plurality of users 107 using plurality of emotion sensing devices for detecting the response of each of the plurality of users 107 for the plurality of PMTs 104 and the associated one or more stimulus 104a. As an example, the emotion sensing interfaces may include plurality of neuroprosthetic devices such as a neural dust sensor, an electroencephalogram, an electro-oculogram or an electrodermal sensor.

At block 303 of the method 300, the multimedia content generator 101 detects a reaction factor 109 of each of the plurality of users 107 in response to viewing of the plurality of PMTs 104 and the associated one or more stimulus 104a. Each of the plurality of PMTs 104 and the associated one or more stimulus 104a may be created and stored in a multimedia theme repository 103 associated with the multimedia content generator 101. In an embodiment, the response of each of the plurality of users 107 may indicate one of presence or absence of an aroused neural signal in each of the plurality of users 107.

At block 305 of the method 300, the multimedia content generator 101 identifies a multimedia theme, from the plurality of PMTs 104, for each of the plurality of users 107 based on the reaction factor 109. In one embodiment, the reaction factor 109 may indicate at least one of level of self-influence and intrinsic drive of the plurality of users 107, emotion of the plurality of users 107, attitude of the plurality of users 107 and influence of the plurality of PMTs 104 and the associated one or more stimulus 104a on the plurality of users 107. In an embodiment, identifying the multimedia theme comprises steps of assigning an emotional score 217 to each of the PMTs 104 based on the reaction factor 109 and selecting one of the plurality of PMTs 104 having the emotional score 217 greater than a predefined threshold emotional score 217.

At block 307 of the method 300, the multimedia content generator 101 identifies an emotion dimension 213 of each of the plurality of users 107 by comparing the reaction factor 109 and one or more emotional metadata 215 related to the one or more stimulus 104a. In one embodiment, the one or more emotional metadata 215 may include at least one of awareness level of the plurality of users 107, acceptance level of the plurality of users 107, emotional bias of the plurality of users 107, cognitive capability of the plurality of users 107 and sensitivity of the plurality of users 107 for the one or more stimulus 104a.

At block 309 of the method 300, the multimedia content generator 101 generates the personalized multimedia content 111 for each of the plurality of users 107 based on the multimedia theme and the emotion dimension 213 corresponding to each of the plurality of users 107. In an embodiment, the multimedia content generator 101 may display the personalized multimedia content 111 on a display unit 105 associated with the plurality of users 107.

In an embodiment, the multimedia content generator 101 further comprises generating a plurality of associated multimedia content related to the personalized multimedia content 111 based on response of each of the plurality of users 107 for the displayed personalized multimedia content 111. Further, the multimedia content generator 101 may create multiple groups among the plurality of users 107 based on socio-demographic data patterns of the plurality of users 107. Upon creating the multiple groups, the multimedia content generator 101 may display a personalized multimedia content 111 to each of the multiple groups based on emotion dimension 213 of each of the plurality of users 107 in each of the multiple groups. Finally, the multimedia content generator 101 may identify a multimedia channel and an optimized schedule in the identified multimedia channel for displaying the personalized multimedia content 111 to the plurality of users 107 based on historical multimedia channel usage data related to each of the plurality of users 107.

Computer System

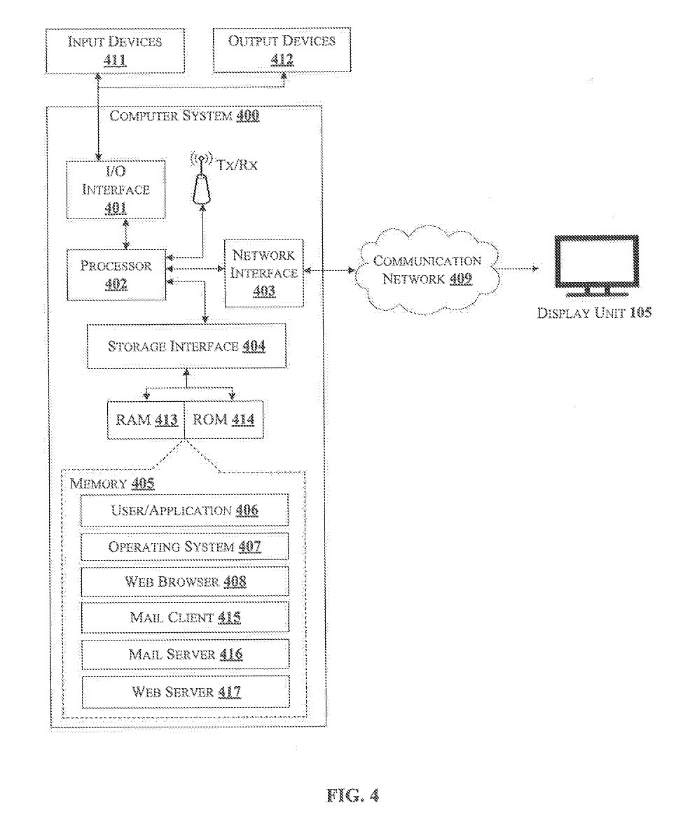

FIG. 4 illustrates a block diagram of an exemplary computer system 400 for implementing embodiments consistent with the present disclosure. In an embodiment, the computer system 400 may be the multimedia content generator 101 which is used for generating the personalized multimedia content 111 for the plurality of users 107. The computer system 400 may comprise a central processing unit (“CPU” or “processor”) 402. The processor 402 may comprise at least one data processor for executing program components for executing user- or system-generated business processes. A user may include a person, a person viewing the multimedia content, a person using a device such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/h/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412). In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

Using the network interface 403 and the communication network 409, the computer system 400 may display plurality of Predetermined Multimedia Themes (PMTs) 104 and associated one or more stimulus 104a to the plurality of users 107 through the display unit 105. The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application data 406, an operating system 407, web server 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, Net BSD, Open BSD, etc.), Linux. distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user interface may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the Embodiment of the Present Disclosure are Illustrated Herein.

In an embodiment, the present disclosure provides a method of creating personalized multimedia content for plurality of users based on response of the plurality of users towards pre-determined multimedia content.

In an embodiment, the present disclosure provides a method of identifying a best suited multimedia theme for the plurality of users based on the innate insight of the users' (viewers of the multimedia content) behavior and preferences.

In an embodiment, the method of present disclosure helps in identifying a multimedia channel through which the personalized multimedia content may be displayed to the users for maximizing the impact of the personalized multimedia content on the users.

In an embodiment, the method of present disclosure assists in building a positive emotion among the users (viewers) by presenting the users a sequentially related subplot over a period through the identified multimedia channel, thereby triggering the interest in the users.

In an embodiment, the present disclosure provides a method of monitoring the footfall downstream of multimedia content to the users, in multiple cycles, for generating a more relevant multimedia content for the user.

In an embodiment, method of present disclosure provides a method of handling self-driven marketing to touch the deep aspirations or inclinations of the consumers, thereby reducing the marketing and sales intervention.

In an embodiment, the method of present disclosure enhances the user experience level through overlapping real, surreal and virtual environments for narrating nested stories that may eventually envelope the users' premises, sometimes evoking nostalgia, to bring out positive emotions in the users.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100A and 100B | Environments |
| 101 | Multimedia content generator |
| 103 | Multimedia theme repository |
| 104 | Predetermined Multimedia Themes (PMTs) |
| 104a | Stimulus |
| 105 | Display unit |
| 107 | Users |
| 109 | Reaction factor |
| 111 | Personalized multimedia content |
| 201 | I/O Interface |
| 203 | Processor |
| 205 | Memory |
| 207 | Modules |
| 209 | Data |
| 213 | Emotion dimension |
| 215 | Emotional metadata |
| 217 | Emotional score |
| 219 | Other data |
| 221 | Emotion sensing module |
| 223 | Emotion dimension identification module |
| 225 | Multimedia theme selection module |
| 227 | Multimedia content generation module |
| 228 | Multimedia content correction module |
| 229 | Multimedia content association module |
| 231 | Other modules |

What is claimed is:

1. A method of generating personalized multimedia content (111) for plurality of users (107), the method comprising:
displaying, by a multimedia content generator (101), plurality of Predetermined Multimedia Themes (PMTs) (104) and associated one or more stimulus (104a) to the plurality of users (107);
detecting, by the multimedia content generator (101), a reaction factor (109) of each of the plurality of users (107) in response to viewing of the plurality of PMTs (104) and the associated one or more stimulus (104a);
identifying, by the multimedia content generator (101), a multimedia theme, from the plurality of PMTs (104), for each of the plurality of users (107) based on the reaction factor (109);
identifying, by the multimedia content generator (101), an emotion dimension (213) of each of the plurality of users (107) by comparing the reaction factor (109) and one or more emotional metadata (215) related to the one or more stimulus (104a); and
generating, by the multimedia content generator (101), the personalized multimedia content (111) for each of the plurality of users (107) based on the multimedia theme and the emotion dimension (213) corresponding to each of the plurality of users (107).

2. The method as claimed in claim 1, further comprising detecting the response of each of the plurality of users (107) for the plurality of PMTs (104) and the associated one or more stimulus (104a) by plurality of neuroprosthetic devices including at least one of a neural dust sensor, an electroencephalogram, an electro-oculogram or an electrodermal sensor.

3. The method as claimed in claim 1, wherein the response of each of the plurality of users (107) upon viewing the plurality of PMTs (104) and the associated one or more stimulus (104a) indicates one of presence or absence of an aroused neural signal in each of the plurality of users (107).

4. The method as claimed in claim 1, wherein each of the plurality of PMTs (104) and the associated one or more stimulus (104a) are created and stored in a multimedia theme repository (103) associated with the multimedia content generator (101).

5. The method as claimed in claim 1, wherein the one or more emotional metadata (215) comprises at least one of awareness level of the plurality of users (107), acceptance level of the plurality of users (107), emotional bias of the plurality of users (107), cognitive capability of the plurality of users (107) or sensitivity of the plurality of users (107) for the one or more stimulus (104a).

6. The method as claimed in claim 1, wherein identifying the multimedia theme comprises:
assigning, by the multimedia content generator (101), an emotional score (217) to each of the PMTs (104) based on the reaction factor (109); and
selecting, by the multimedia content generator (101), one of the plurality of PMTs (104) having the emotional score (217) greater than a predefined threshold.

7. The method as claimed in claim 1, wherein the reaction factor (109) indicates at least one of level of self-influence of the plurality of users (107), intrinsic drive of the plurality of users (107), emotion of the plurality of users (107), attitude of the plurality of users (107) or influence of the plurality of PMTs (104) and the associated one or more stimulus (104a) on the plurality of users (107).

8. The method as claimed in claim 1 further comprising generating a plurality of associated multimedia content related to the personalized multimedia content (111) based on response of each of the plurality of users (107) to displayed personalized multimedia content (111).

9. The method as claimed in claim 1 further comprising:
creating, by the multimedia content generator (101), multiple groups among the plurality of users (107) based on socio-demographic data patterns of the plurality of users (107); and
displaying, by the multimedia content generator (101), a personalized multimedia content (111) to each of the multiple groups based on the emotion dimension (213) of each of the plurality of users (107) in each of the multiple groups.

10. The method as claimed in claim 1 further comprising identifying a multimedia channel and an optimized schedule in the identified multimedia channel for displaying the personalized multimedia content (111) to the plurality of users (107) based on historical multimedia channel usage data related to each of the plurality of users (107).

11. A multimedia content generator (101) for generating personalized multimedia content (111) for plurality of users (107), the multimedia content generator (101) comprises:
a processor (203); and
a memory, communicatively coupled to the processor (203), wherein the memory stores processor-executable instructions, which, on execution, causes the processor (203) to:
display plurality of Predetermined Multimedia Themes (PMTs) (104) and associated one or more stimulus (104a) to the plurality of users (107);
detect a reaction factor (109) of each of the plurality of users (107) in response to viewing of the plurality of PMTs (104) and the associated one or more stimulus (104a);
identify a multimedia theme, from the plurality of PMTs (104), for each of the plurality of users (107) based on the reaction factor (109);
identify an emotion dimension (213) of each of the plurality of users (107) by comparing the reaction factor (109) and one or more emotional metadata (215) related to the one or more stimulus (104a); and
generate the personalized multimedia content (111) for each of the plurality of users based on the multimedia theme and the emotion dimension (213) corresponding to each of the plurality of users (107).

12. The multimedia content generator (101) as claimed in claim 11, wherein the processor (203) is further configured to detect the response of each of the plurality of users (107) to the plurality of PMTs (104) and the associated one or more stimulus (104a) using plurality of neuroprosthetic devices including at least one of a neural dust sensor, an electroencephalogram, an electro-oculogram or an electrodermal sensor.

13. The multimedia content generator (101) as claimed in claim 11, wherein the response of each of the plurality of users (107) upon viewing the plurality of PMTs (104) and the associated one or more stimulus (104a) indicates one of presence or absence of an aroused neural signal in each of the plurality of users (107).

14. The multimedia content generator (101) as claimed in claim 11, wherein the processor (203) creates and stores each of the plurality of PMTs (104) and the associated one or more stimulus (104a) in a multimedia theme repository (103) associated with the multimedia content generator (101).

15. The multimedia content generator (101) as claimed in claim 11, wherein the one or more emotional metadata (215) comprises at least one of awareness level of the plurality of users (107), acceptance level of the plurality of users (107), emotional bias of the plurality of users (107), cognitive capability of the plurality of users (107) or sensitivity of the plurality of users (107) for the one or more stimulus (104a).

16. The multimedia content generator (101) as claimed in claim 11, wherein to identify the multimedia theme, the processor (203) is configured to:
assign an emotional score (217) to each of the PMTs (104) based on the reaction factor (109); and
select one of the plurality of PMTs (104) having the emotional score (217) greater than a predefined threshold.

17. The multimedia content generator (101) as claimed in claim 11, wherein the reaction factor (109) indicates at least one of level of self-influence of the plurality of users (107), intrinsic drive of the plurality of users (107), emotion of the plurality of users (107), attitude of the plurality of users (107) or influence of the plurality of PMTs (104) and the associated one or more stimulus (104a) on the plurality of users (107).

18. The multimedia content generator (101) as claimed in claim 11, wherein the processor (203) further generates a plurality of associated multimedia content related to the personalized multimedia content (111) based on response of each of the plurality of users (107) to displayed personalized multimedia content (111).

19. The multimedia content generator (101) as claimed in claim 11, wherein the processor (203) is further configured to:
create multiple groups among the plurality of users (107) based on social demographic data patterns of the plurality of users (107); and
display a personalized multimedia content (111) to each of the multiple groups based on the emotion dimension (213) of each of the plurality of users (107) in each of the multiple groups.

20. The multimedia content generator (101) as claimed in claim 11, wherein the processor (203) identifies a multimedia channel and an optimized schedule in the identified multimedia channel to display the personalized multimedia content (111) to the plurality of users (107) based on historical multimedia channel usage data related to each of the plurality of users (107).
